(19) United States
(12) Patent Application Publication
(10) Pub. No.: US 2008/0139356 A1
(43) Pub. Date: Jun. 12, 2008

(54) Rocker joint chain

(75) Inventor: André Teubert, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Bühl (DE)

(21) Appl. No.: 11/986,979

(22) Filed: Nov. 27, 2007

Related U.S. Application Data
(60) Provisional application No. 60/861,238, filed on Nov. 27, 2006.

(51) Int. Cl. F16G 13/06; F16G 5/18; F16H 55/56

(52) U.S. Cl. 474/215; 474/8

(57) ABSTRACT

A rocker joint chain having a plurality of chain links, each chain link including at least one link plate. The chain links are connected to each other in a pivoting manner at rocker joints, and the rocker joints each include a rocker member having at least two cylindrical rocker pins that contact each other by rolling or sliding on each other.

### BACKGROUND OF THE INVENTION

1. Field of the Invention

The present invention relates to a rocker joint chain.

2. Description of the Related Art

Rocker joint chains are used as link plate chains in chain drive transmissions, such as CVT transmissions, variable speed drive transmissions, or as toothed plate link chains in silent chain drives. The rocker joints include rocker pins that roll or slide against each other, and generally have a cross-sectional shape that is difficult to manufacture and thus is expensive to produce.

It is an object of the present invention to provide a rocker joint chain having rocker pins that are economical to manufacture.

### SUMMARY OF THE INVENTION

The object is achieved in a rocker joint chain that includes a plurality of chain links, each chain link having at least one link plate, wherein the chain links are connected with each other by rocker joints and the rocker joints each include at least two rocker pins that roll or slide against each other, wherein the rocker pins are cylindrical pins. The cylindrical pins can be manufactured very precisely and in an economical manner. Such manufacturing methods are known from the manufacture of needle bearings, for example.

Preferably, the cylindrical pins are arranged distributed when viewed in a plane that is perpendicular to the running direction of the chain, wherein at least one of the pins is offset relative to an associated rocker pin in the chain running direction. Preferably, the axes of the pins lie on a circular arc.

In a preferred embodiment the rocker members each include three pins. Preferably, the middle one of the three pins is in contact with a pin of the other rocker member with which the rocker joint is formed, wherein both outer pins are supported against the link plates and wherein the middle pin is supported against both outer pins. Thereby, a two-point contact with the link plates and a point contact between the rocker members are assured.

In a plate-link chain in a continuously variable transmission, the middle one of the three pins can extend beyond the two other pins of the rocker member in the longitudinal direction of the pins at both ends of the middle pin. Thereby, only one of the pins of a rocker member is in contact with the conical discs of the transmission. Preferably, it is provided that at least one of the pins is securely connected with at least outer link plates of the chain links. The connection can be friction-locked, form-locked, or bonded, especially a press fit. The pins can have identical or different diameters.

The above object is also achieved through the use of a rocker joint chain in a belt-driven conical-pulley transmission (also designated as a CVT drive).

### BRIEF DESCRIPTION OF THE DRAWINGS

The structure, operation, and advantages of the present invention will become further apparent upon consideration of the following description, taken in conjunction with the accompanying drawings in which:

FIG. 1 is a side view of a known rocker joint chain;

FIG. 2 is a top view of the rocker joint chain shown in FIG. 1;

FIG. 3 is a cross-sectional view along the line I-I of the chain shown in FIG. 2 showing an embodiment of a rocker joint chain in accordance the present invention.

### DESCRIPTION OF THE PREFERRED EMBODIMENTS

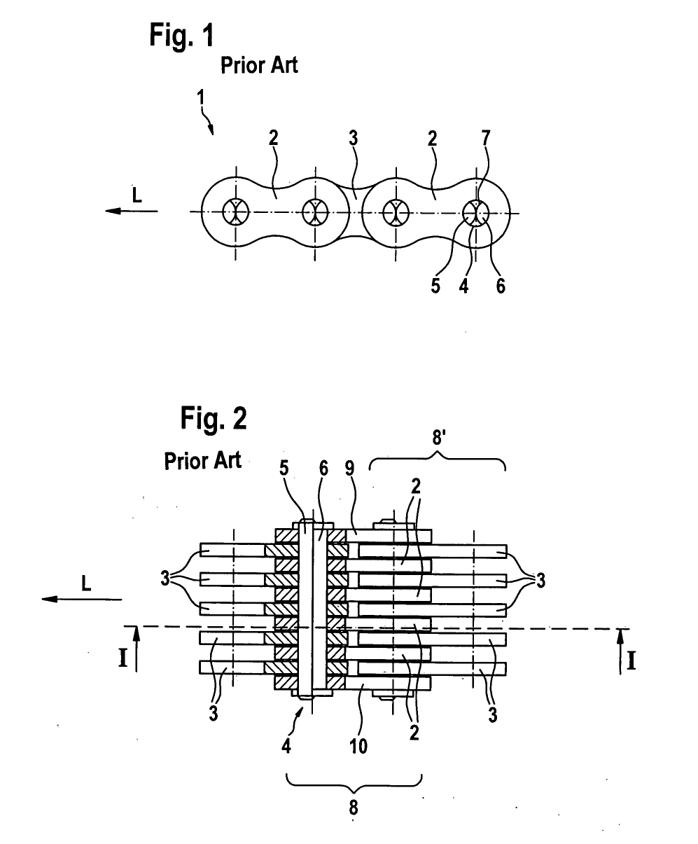

FIG. 1 shows a side view, and FIG. 2 shows a top view of a known rocker joint chain 1, which is provided as a plate-link chain with a two-link plate connection. On the basis of FIGS. 1 and 2 the fundamental construction of rocker joint chains and the terms used in the embodiments in accordance with the invention are described. The embodiments are described with reference to a rocker joint chain with a two link plate connection, but they are also applicable to a plate-link chain having a three link plate connection.

The rocker joint chain 1 includes a plurality of chain links, each of which is formed by link plates 2 and opposed link plates 3. The link plates 2 and the opposed link plates 3 are respectively disposed in an alternating manner, and are pivotally connected by rocker joints 4. Both ends of a link are thus connected at a rocker joint with one or two opposed links, and correspondingly both ends of an opposed link are connected by a rocker joint with one or two links. The rocker joints 4 each include two rocker members 5, 6, wherein a rocker member 5 is associated with the respective link plates 2, and rolls against a rocker member 6 that is associated with the opposed link plate 3.

The rocker pins 5, 6 each include a roller profile 7, through which they can roll against or slide relative to each other. In a transverse direction to the running direction L, which is represented by an arrow with the designation L, the link plates 2 and the opposed link plates 3 are stacked to form chain links 8 or 8′ in an alternating manner, so that between two link plates 2 disposed next to each other, an overlapping opposed link plate 3 is disposed, and on the other hand, between two opposed link plates 3 lying next to each other, transverse to the running direction of the chain, a respective overlapping link plate 2 is disposed. That, of course, does not apply to the outer link plates 9 or 10, which are respectively outwardly disposed perpendicular to the running direction L of the chain. The outer link plates only have a neighbor on only one side. The link plate sets formed by link plates 2 are so constituted as to each form a chain link 8 as a stack of plates; correspondingly the (opposed-) link plate sets of opposed link plates 3 form a chain link 8′ as a stack of plates. The link plates 2 and the opposed link plates 3 can be identical components in the present exemplary embodiment, a difference between link plates 2 and opposed link plates 3 is only recognizable by their arrangement within the rocker joint chain 1. Therefore, subsequently only link plates 2 will be referred to, since those are identical with the opposed link plates 3, except for their stack-wise disposition. In FIG. 2, in each case a stack of six link plates 2 and five opposed link plates 3 is shown. But stacks with any other number of link plates 2 and opposed link plates 3 can also be provided.

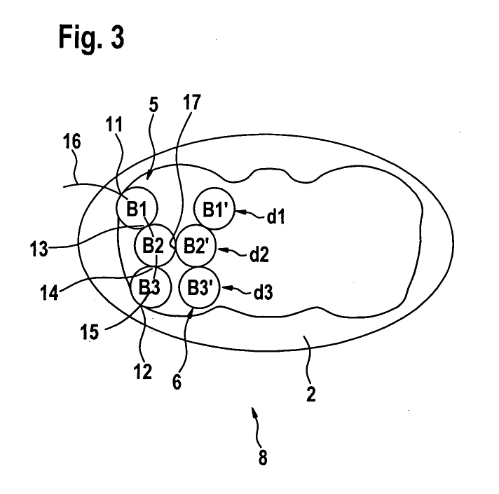

FIG. 3 shows a side view of a single chain link 8 in accordance with the present invention in a view similar to that of FIG. 1. The view is a longitudinal sectional view through a chain in the manner of line I-I of FIG. 2, showing a side view of a single link plate 2 in which the cutting plane passes transversely through the rocker pins 5, 6. The rocker pin 5 is formed from three round pins designated B1, B2, and B3, each having the same diameter. The rocker pin 6 is provided in mirror symmetry to the rocker pin 5, with which it forms the rocker joint 4, and it is composed of round pins designated B1′, B2′, and B3′. The pin B1 contacts and bears against link plate 2 at contact point 11, and the pin B3 contacts and bears against link plate 2 at contact point 12. The pin B2 contacts and bears against pin B1 at contact point 13 and contacts and bears against pin B3 at contact point 14. The longitudinal axis 15 of the pin B3, which for purposes of clarity is the only pin axis shown in FIG. 3, and the rotation axes of each of the pins B1 and B2, which are not shown in FIG. 3, each lie on a circular arc 16. The pins B1′, B2′, and B3′ are connected through an opposed link plate 3 (not shown in FIG. 3) that extends in the running direction of the chain.

The pins B1, B2, and B3 and B1′, B2′, and B3′ are thus arranged so that only the respective center pins B2 and B2′ touch each other at a rolling contact point 17. The longitudinal axes of pins B1, B2, and B3, and also those of pins B1′, B2′, and B3′, lie in respective planes that are perpendicular to the chain running direction L, wherein at least one of the pins, B2 and B2′ in this case, is arranged offset from the associated rocker member 5, 6 in the chain running direction L. In this context, a piece is designated an associated rocker pin, together with which the rocker joint is formed. Associated rocker joints thus roll against each other, or slide relative to each other. In the illustration in FIG. 1 the rocker members 5 and 6 are associated with each other.

In case of a deflection of the rocker joint chain 1, the pins B2 and B2′ roll against or slide on each other at the rolling contact point 17, while the pins B1 and B1′, or B3 and B3′, do not come into contact. The pins B1, B2, and B3, or B1′, B2′, and B3′ thus form respective rocker members 5, 6, each with a two-point contact with the respective link plate 2, or the counter link plate 3, and only roll or slide on the respective associated rocker pin 5, 6, with which they form the rocker joint 4, in one location, in this case the rolling point 17. The pins B1 and B3 or B1′ and B3′ form the contact region to the link plate 2, or to the opposed link plate 3, assuring the two-point contact. The pin B2 is supported against B1 and B3, forming the rolling surface for the opposite partner, formed in this case by the pins B1′, B2′, and B3′.

The pins B1 and B3 are preferably pressed together with the link plates 2 or connected with the link plates 2 in another form locking manner. Accordingly, the pins B1′ and B3′ are connected in a form-locking manner with the opposed link plates 3. Instead of a form locked connection, a press connection, for example, and also glue joints, or welds, or similar are conceivable. It is also possible that the pins B1, B2, B3, B1′, B2′, and B3′ are not connected with the respective internally located link plates 2, or counter link plates 3, thus floatingly supported in them, and only firmly connected with the end link plates 9 or 10 in a manner in accordance with FIG. 2. In particular in a rocker joint chain that runs between conical pulleys in a continuously variable transmission (CVT), it is also possible to support the pins completely free floating within the chain. In such a transmission it can furthermore be provided that only some of the pins come into contact with the conical pulleys. That is accomplished through different axial lengths of the pins in direction of the axis of symmetry (rotation axis) 15. Hereby it is preferably provided that only the pins B2 and B2′ are in contact with the conical pulleys, thus the pins B2 and B2′ are longer than the pins B1, B3, B1′, and B3′. The pins in the present embodiment have the same diameters d1, d2, and d3, however they can also be different.

The rocker joint chain 1 can certainly also be provided as a toothed link plate chain. Furthermore, the link plate chain (with teeth) can include guidance link plates within the link plate chain, or on both sides.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A rocker joint chain comprising: a plurality of chain links each including at least one link plate, wherein the chain links are connected to each other in a pivoting manner at rocker joints, wherein the rocker joints each include two rocker members that contact each other, and wherein each of the rocker members includes at least two cylindrical pins.

2. A rocker joint chain in accordance with claim 1, wherein the pins are each arranged to extend in a plane that is perpendicular to the running direction of the chain, and wherein at least one of the pins of a rocker member is disposed offset in the chain running direction from the other pin of that rocker member, towards an associated rocker member.

3. A rocker joint chain in accordance with claim 2, wherein the axes of the pins of a rocker member lie on a circular arc.

4. A rocker joint chain in accordance with claim 3, wherein the rocker members each include three pins.

5. A rocker joint chain in accordance with claim 4, wherein a middle pin of the three pins of a rocker member is in contact with a middle pin of an associated rocker member with which a rocker joint is formed, and two outer pins of each rocker member are in contact with the link plates, and wherein the middle pin of a rocker member is in contact with both outer pins of that rocker member.

6. A rocker joint chain in accordance with claim 5, wherein outer longitudinal ends of the middle pin of the three pins of a rocker member extend beyond longitudinal ends of the two other pins of the rocker member.

7. A rocker joint chain in accordance with claim 5, wherein at least one of the pins of a rocker member is rigidly connected with outer link plates of the chain links.

8. A rocker joint chain in accordance with claim 5, wherein the pins have identical diameters.

9. A rocker joint chain in accordance with claim 5, wherein the pins have different diameters.

10. A conical pulley drive including a rocker joint chain in accordance with claim 1.
